(19) United States
(12) Patent Application Publication
(10) Pub. No.: US 2026/0131268 A1
(43) Pub. Date: May 14, 2026

(54) VALVE TYPE NO FILTER NO RUN FILTRATION SYSTEM

(71) Applicant: Cummins Filtration Inc., Nashville, TN (US)

(72) Inventors: Wassem Abdalla, Fishers, IN (US); Jayant Singh, Pune (IN); Pravin Shantinath Kadam, Kolhapur (IN); Jaya Tripathi, Pune (IN)

(73) Assignee: Cummins Filtration Inc., Nashville, TN (US)

(21) Appl. No.: 19/120,115

(22) PCT Filed: May 31, 2023
(86) PCT No.: PCT/US2023/023943

§ 371 Date: Apr. 10, 2025

(30) Foreign Application Priority Data
Oct. 18, 2022 (IN) 202241059559

(51) Int. Cl. B01D 35/147; B01D 29/13; B01D 35/00; F02M 37/32

(52) U.S. Cl. CPC B01D 35/147; B01D 29/13; B01D 35/005; B01D 2201/0453; B01D 2201/167; B01D 2201/303; B01D 2201/4092; F02M 37/32

(57) ABSTRACT

Systems and methods for a no-filter no-run filter are provided herein. A filter assembly includes a filter head and a filter cartridge. The filter head includes a first port and a valve positioned within the first port. The filter cartridge includes a shell having a shell wall defining an internal volume and a filter element disposed within the internal volume. The filter element includes a filter media and a first endplate coupled to the filter media at a filter media first end. The first endplate includes an endplate end wall and an arm extending axially away from the endplate end wall such that the arm contacts the valve.

### CROSS-REFERENCE TO RELATED APPLICATION

This application is a U.S. National Phase of PCT Application No. PCT/US2023/023943, filed May 31, 2023, which claims the benefit and priority to India Provisional Application No. 202241059559, filed Oct. 18, 2022. The contents of these applications are incorporated herein by reference in their entirety.

### FIELD

The present application generally to fluid filtration assemblies for use in supplying filtered fluid to downstream devices.

### BACKGROUND

Internal combustion engines generally combust a mixture of fuel (e.g., diesel, gasoline, natural gas, etc.) and air. Prior to entering the engine, the fuel is typically passed through a filter cartridge to remove particulate matter (e.g., dust, metal particles, debris, etc.) from the fuel prior to combustion. Similarly, lubricant or lube (e.g., engine oil) provided to the engine may also be passed through a filter cartridge so as to remove particulate matter from the lube before communicating to the engine.

Filter elements (e.g., filter cartridges) often include a sealing feature that forms a seal between the filter elements and a filter head. The seal prevents fluid from bypassing the filter element (e.g., for air to bypass an air filter element or liquid to bypass a liquid filter element). In many filter systems, if a filter element is not installed, unfiltered fluid may cause damage to downstream components. Accordingly, failure to install a filter element, or installing an incompatible filter element, can harm critical components in the filtration system, diminish emission compliance mechanisms, cause subpar performance, and the like.

### SUMMARY

Various embodiments provide for a filter assembly. The filter assembly includes a filter head and a filter cartridge. The filter head includes a first port and a valve positioned within the first port. The filter cartridge includes a shell having a shell wall defining an internal volume and a filter element disposed within the internal volume. The filter element includes a filter media and a first endplate coupled to the filter media at a filter media first end. The first endplate includes an endplate end wall and an arm extending axially away from the endplate end wall such that the arm contacts the valve.

Various other embodiments provide for a filter head assembly. The filter head assembly includes a filter head including a port and a valve disposed within the port. The valve includes a valve wall, a first sidewall extending away from the valve wall in a first direction, a second sidewall extending away from the valve wall in the first direction, and a column extending away from the valve wall in a second direction, opposite the first direction.

Various other embodiments provide for a method of installing a filter cartridge with a filter head. The method includes rotating the filter cartridge relative to the filter head such that a shell thread of a shell of the filter cartridge engages a filter head thread of the filter head; and contacting a prong of the filter head with a rib of an endplate of the filter cartridge, thereby preventing further rotation of the endplate of the filter cartridge relative to the filter head.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1A is a perspective view of a filter assembly, according to an example embodiment.

FIG. 1B is a perspective view of the filter assembly of FIG. 1A, shown with a pump disposed at a filter head.

FIG. 2A is a cross-sectional view of a portion of the filter assembly of FIG. 1B.

FIG. 2B is a perspective view of a filter element usable in the filter assembly of FIG. 1B FIG. 3A is a bottom perspective view of a filter head of the filter assembly of FIG. 1B.

FIG. 3B is a detailed perspective view of the filter head of FIG. 3A.

FIG. 4A is a top perspective view of a valve of the filter assembly of FIG. 1B.

FIG. 4B is a bottom perspective view of the valve of FIG. 4A.

FIG. 4C is a bottom view of the valve of FIG. 4A.

FIG. 4D is a cross-sectional perspective view of a sealing member of the filter assembly of FIG. 1B.

FIG. 5A is a front cross-sectional view showing a portion of the filter assembly of FIG. 1B, shown without a genuine filter element.

FIG. 5B is another side cross-sectional view showing a portion of the filter assembly of FIG. 1B, shown without a genuine filter element.

FIG. 5C is a detailed front cross-sectional view showing a portion of the filter assembly of FIG. 1B, shown without a genuine filter element.

FIG. 5D is a top perspective cross-sectional view showing a portion of the filter assembly of FIG. 1B, shown without a genuine filter element.

FIG. 6A is a front cross-sectional view showing a portion of the filter assembly of FIG. 1B, shown with a genuine filter element.

FIG. 6B is a side cross-sectional view showing a portion of the filter assembly of FIG. 1B, shown with a genuine filter element.

FIG. 6C is another side cross-sectional view showing a portion of the filter assembly of FIG. 1B, shown with a genuine filter element.

FIG. 7A is a perspective view of an example endplate usable in the filter assembly of FIG. 1B, according to an example embodiment.

FIG. 7B is a perspective view of a portion of a shell usable in of the filter assembly of FIG. 1B, according to an example embodiment.

FIG. 7C is a perspective view of an example filter element including the endplate of FIG. 7A being installed in the shell of FIG. 7B.

FIG. 8A is a perspective view of a portion of an example filter cartridge usable in the filter assembly of FIG. 1B, according to an example embodiment.

FIG. 8B is a perspective view showing a portion of the filter cartridge of FIG. 8A.

FIG. 8C is a perspective view showing a portion of the filter cartridge of FIG. 8A.

FIG. 9A is a cross-sectional view showing a portion of the filter assembly of FIG. 1B, shown in a partially assembled state.

FIG. 9B is another cross-sectional view showing a portion of the filter assembly of FIG. 1B, shown in a partially assembled state.

FIG. 10A is a cross-sectional view showing a portion of the filter assembly of FIG. 1B, shown in an assembled state.

FIG. 10B is a top cross-sectional view showing a portion of the filter assembly of FIG. 10A.

FIG. 10C is a bottom cross-sectional view showing a portion of the filter assembly of FIG. 10A.

FIG. 11A is a cross-sectional view showing a portion of the filter assembly of FIG. 1B, shown without a genuine filter element installed.

FIG. 11B is a cross-sectional view showing a portion of the filter assembly of FIG. 1B, shown with a genuine filter element installed.

FIG. 12A is a cross-sectional view showing a portion of a filter assembly, shown without a genuine filter element installed, according to an example embodiment.

FIG. 12B is a cross-sectional view showing a portion of the filter assembly of FIG. 12A, shown with a genuine filter element installed.

FIG. 13A is a cross-sectional view showing a portion of a filter assembly, according to another example embodiment.

FIG. 13B is a perspective view showing a portion of an example filter element usable in the filter assembly of FIG. 13A, shown in a disassembled state.

FIG. 13C is a perspective view showing a portion of an example endplate of the filter element of FIG. 13B.

FIG. 14A is a cross-sectional view showing a portion of a filter assembly, according to another example embodiment.

FIG. 14B is a perspective view showing a portion of an example filter element usable in the filter assembly of FIG. 14A, shown in a disassembled state.

FIG. 14C is a perspective view showing a portion of an example endplate usable in the filter assembly of FIG. 14A.

FIG. 15A is a cross-sectional view showing a portion of a filter assembly, according to another example embodiment.

FIG. 15B is a perspective view showing a portion of an example filter element usable in the filter assembly of FIG. 15A, shown in a disassembled state.

FIG. 15C is a perspective view showing a portion of an example endplate usable in the filter assembly of FIG. 15A.

### DETAILED DESCRIPTION

Embodiments described herein relate generally to a no-filter no-run filter assembly. According to various embodiments, the no-filter no-run filter assembly includes a no-filter no-run feature configured to operationally prevent a downstream device, such as an engine, from operating when a filter element is not installed or when an unauthorized filter element is installed. The no-filter no-run feature may advantageously improve the ease of serviceability by ensuring that an authorized filter element is properly installed within the filter assembly.

Before turning to the figures, various embodiments of no-filter no-run filter assembly and components thereof are described herein. It should be understood that, while individual components are described in detail, the details should be considered as examples only. Further, the details may include variations described herein. Accordingly, it should be understood that, although individual components may be described relative to an embodiment, any of the components may be used in any other embodiment described herein, unless otherwise noted.

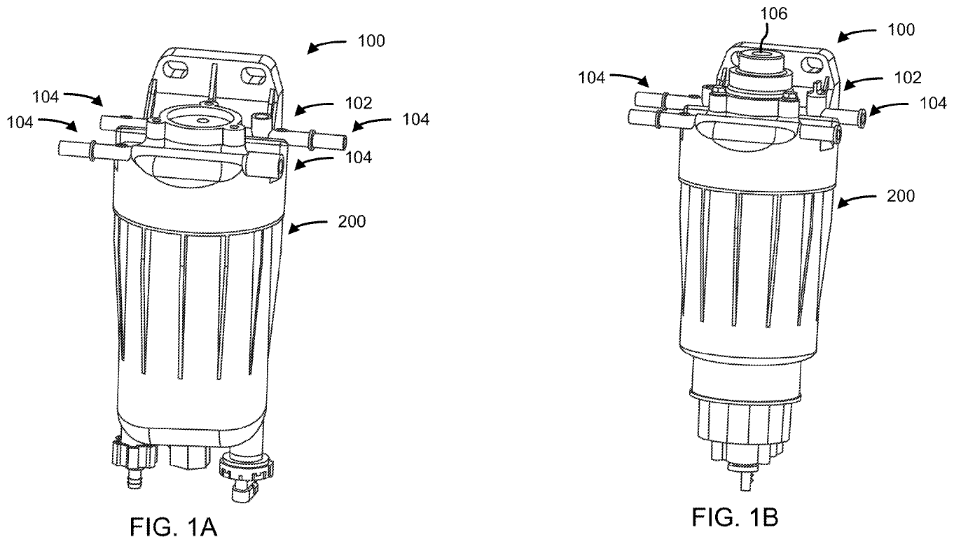

Referring to FIGS. 1A and 1B, perspective views of a filter assembly 100 are shown, according to an example embodiment. As shown in FIG. 1A, the filter assembly 100 includes a filter head 102 and a filter cartridge 200. As shown in FIG. 1B, the filter assembly 100 may also include a pump 106 disposed at the filter head 102. It should be understood that the filter assembly 100 may include more or fewer components than as shown in FIGS. 1A and 1B.

The filter head 102 includes one or more ports 104. At least one of the ports 104 is an inlet in fluid receiving communication with an upstream device (e.g., a fluid pump, a fluid storage tank, etc.). For example, the inlet provides a dirty or unfiltered fuel to the filter assembly 100. At least one of the ports 104 is an outlet in fluid providing communication with a downstream device (e.g., an engine). For example, the outlet provides a filtered fuel to a downstream component, such as an engine. The filter head 102 may include a pump 106. The pump 106 is configured to enable receiving and/or providing fluid by one or more of the ports 104.

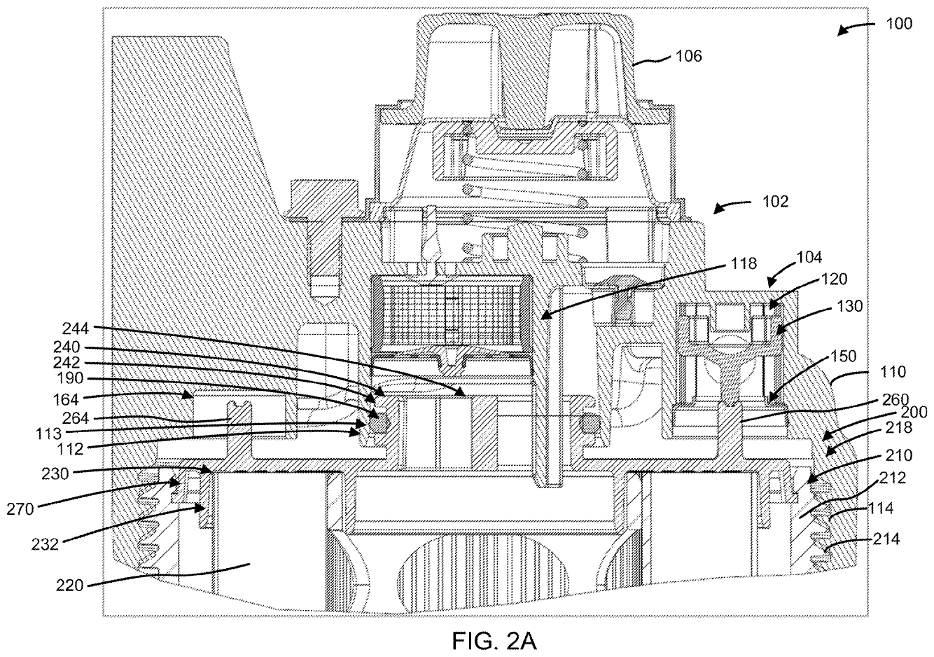

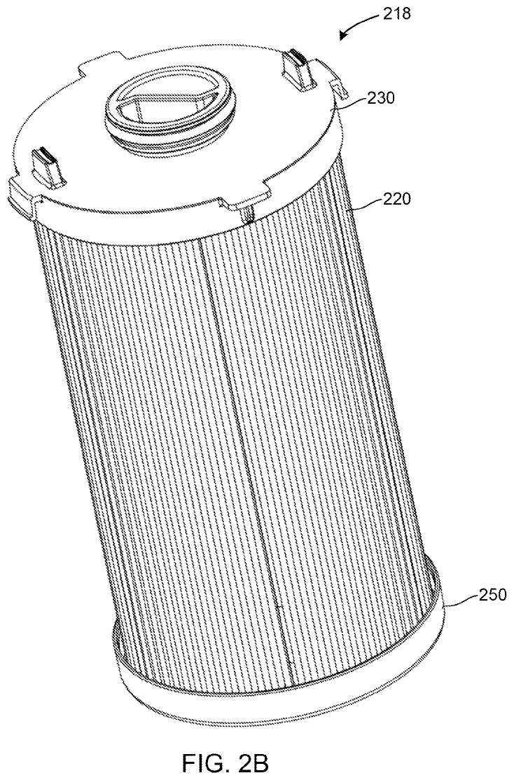

FIG. 2A is a cross-sectional view of a portion of the filter assembly 100 shown in FIG. 1B. The filter assembly 100 includes a filter head assembly and the filter cartridge 200. The filter head assembly includes the filter head 102 and a valve 130. The filter cartridge 200 includes a shell 210 and a filter element 218. FIG. 2B is a perspective view of the filter element 218.

The filter head 102 includes a filter head wall 110 and one or more inward facing threads shown as filter head threads 114. The filter head threads 114 are configured to receive one or more outward facing threads, such as one or more outward facing treads shown as shell threads 214 of the shell 210.

The filter head wall 110 defines a valve port 120 proximate at least one of the ports 104, such that the valve port 120 is in fluid communication with at least one of the ports 104. The valve port 120 is configured to receive the valve 130 therein, such that the valve 130 is at least partially contained within the valve port 120. The valve 130 may be operable between an open position and a closed position. In some embodiments, a sealing member 150 may be positioned within the valve port 120, as shown in FIG. 2A. The sealing member 150 may be a plastic member configured to contact the valve 130 when the valve 130 is in the closed position and form a seal therebetween. The valve port 120, the valve 130, and the sealing member 150 are described in further detail herein below.

The filter head wall 110 defines a prong 118 extending axially towards the filter element 218. The prong 118 is described in further detail herein below.

The filter head wall 110 defines a pump port 112. The pump port 112 is configured to receive at least a portion of the filter element 218 therein. The pump port 112 defines a filter head sealing surface 113. The filter head sealing surface 113 is structured to form a first circumferential, radially-directed seal with a sealing member 190 (e.g., an o-ring gasket or the like).

The filter head wall 110 defines a recess 164 positioned away from the valve port 120 (e.g., diametrically opposite the valve port 120). The recess 164 is configured to receive at least a portion of the filter element 218.

The shell 210 includes a shell wall 212 and the one or more shell threads 214 extending radially outward, away from the shell wall 212. The shell 210 defines an internal volume, such that the shell 210 is structured to receive the filter element 218 at least partially within the internal volume. The shell 210 is removably coupled to the filter element 218. The coupling between the shell 210 and the filter element 218 is described in further detail herein, below.

As shown in FIG. 2B, the filter element 218 includes a filter media 220 fitted between a first endplate 230 and a second endplate 250. For example the first endplate 230 is coupled to the filter media 220 at a filter media first end, and the second endplate 250 is coupled to the filter media 220 at a filter media second end, opposite the first end. The filter media 220 may include one or more media layers such as a pleated and/or woven filter media, a hydrophobic screen, and/or any other suitable filter media layer.

As shown in FIG. 2A, the first endplate 230 includes an endplate end wall 231, an endplate port 240 extending axially away from the endplate end wall 231 in a first direction, towards the filter head 102, a filter media channel 232 extending axially away from the endplate end wall 231 in a second direction, opposite the first direction and towards the filter media 220, and first coupling members 270 extending radially away from the endplate end wall 231. The filter media channel 232 is configured to receive at least a portion of the filter media 220 such that the filter media 220 is coupled to the endplate 230.

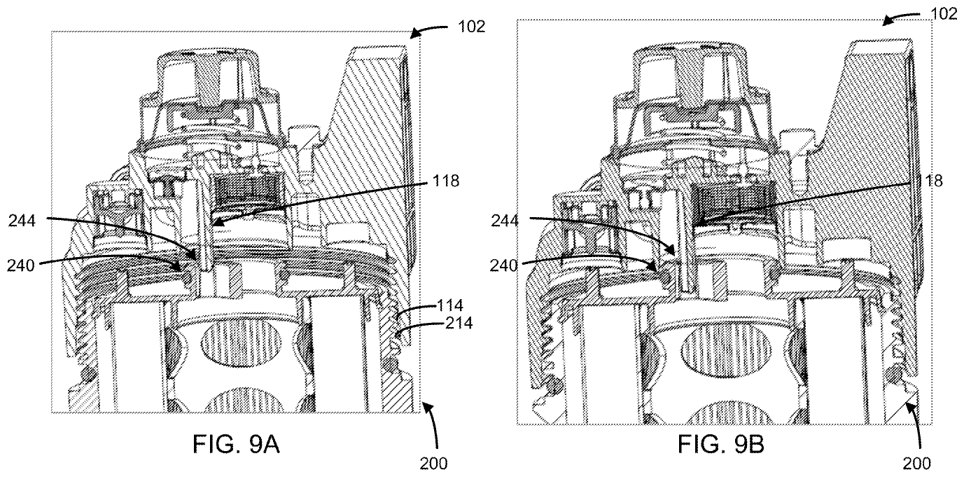

The endplate port 240 is structured to enable fluid communication between an inner volume of the filter element 218 and the pump port 112. The endplate port 240 includes a sealing channel 242 extending radially outwards towards the pump port 112. The sealing channel 242 is configured to at least partially retain the sealing member 190 therein, such that the sealing member 190 forms a seal between the filter head sealing surface 113 and the sealing channel 242. The endplate port 240 also includes a rib 244 that extends across the diameter of the endplate port 240. In some embodiments, the rib 244 may include one or more traverse portions. The prong 118 may extend through the pump port 112 and the endplate port 240 such that a portion of the rib 244 (e.g., a traverse portion) contacts the prong 118. The rib 244 is described in more detail herein with respect to FIGS. 9A and 9B.

The first coupling members 270 are structured to couple the filter element 218 to the shell 210. In some embodiments, the first coupling members 270 may couple the filter element 218 to the shell 210 in a snap-fit arrangement. In some embodiments, the first coupling members 270 may secure the filter element 218 relative to the shell 210 in an axial and a radial direction, and allow the filter element 218 to move relative to the shell 210 in a circumferential (e.g., rotational) direction.

The first endplate 230 also includes a first arm 260 and a second arm 264 that extend axially away from the endplate end wall 231 in the first direction, towards the filter head 102. The first arm 260 is positioned such that the first arm 260 is at least partially received by the valve port 120. The first arm 260 is configured to contact a portion of the valve 130 and bias the valve 130 to the open position. The second arm 264 is positioned diametrically (or substantially diametrically) opposite the first arm 260 such that the second arm 264 is received by the recess 164. It should be understood that the positioning of the first arm 260 relative to the second arm 264 as shown in FIG. 2A is shown as an example only. In additional and/or alternative embodiments, the first arm 260 and the second arm 264 may have different positioning relative to each other. The first arm 260 and the second arm 264 are described in further detail herein, below.

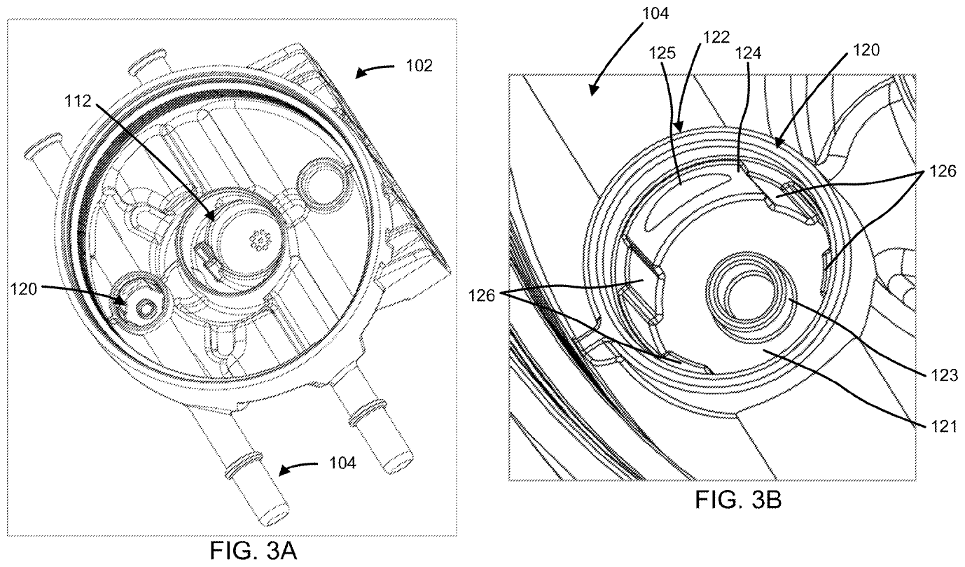

Now referring to FIGS. 3A and 3B, perspective views of the filter head 102 are shown. As shown in FIG. 3A, the filter head 102 includes the valve port 120 and a pump port 112. The pump port 112 may be in fluid communication with at least one of the ports 104 and/or the pump 106. As shown in FIG. 3B, the valve port 120 includes a closed end defined by a valve port wall 121 and an open end defined by a valve port opening 122. The valve port 120 includes an annular wall 123 that extends away from the valve port wall 121 towards the valve port opening 122. The valve port 120 also includes a valve port sidewall 124 that extends between the valve port wall 121 and the valve port opening 122. The valve port sidewall 124 includes one or more openings 125 such that the valve port 120 is in fluid communication with one or more ports 104. The valve port 120 also includes one or more projections 126 extending radially inwards from the valve port sidewall 124.

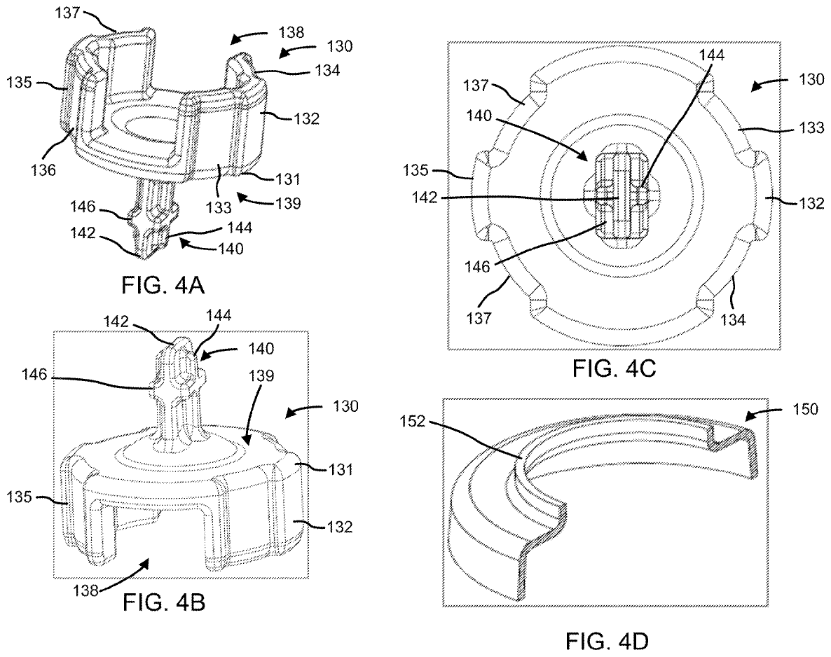

Now referring to FIGS. 4A-4C, various views of an example valve 130 usable in the filter assembly 100 of FIG. 1B are shown, according to an example embodiment. The valve 130 may be made of a plastic material, a metal material (e.g., steel), or any other suitable material. The valve 130 includes a valve wall 131, a valve first sidewall 132 extending away from the valve wall 131 in a first direction and a valve second sidewall 134 diametrically opposite the valve first sidewall 132 and extending in the first direction. The valve first sidewall 132 is spaced away from the valve second sidewall 134 such that a channel 138 is defined between the valve first sidewall 132 and the valve second sidewall 134. The channel 138 is in fluid communication with one or more of the ports 104. The valve 130 also includes a column 140 extending away from the valve wall 131 in a second direction, opposite the first direction.

The valve first sidewall 132 includes one or more recesses 133. The valve second sidewall 134 includes one or more recesses 135. The one or more recesses 133, 135 are configured to receive the one or more projections 126 of the valve port 120 such that the valve 130 is fixed relative to the valve port 120 in a radial direction and a rotational direction, and is free to translate in an axial direction.

The column 140 includes a first rib 142, a second rib 144, and a third rib 146. The first rib 142 extends axially away from a bottom surface 139 of the valve wall 131. The second rib 144 extends axially away from the bottom surface 139 of the valve wall 131 and is substantially perpendicular to the first rib 142. The third rib 146 is spaced away from the bottom surface 139 of the valve wall 131 and is substantially parallel to the bottom surface 139 and perpendicular to the first rib 142 and the second rib 144. The first rib 142 extends further away from the bottom surface 139 than the second rib 144, such that a distal end of the first rib 142 extends past a distal end of the second rib 144. The third rib 146 is positioned between the bottom surface 139 and the distal end of the second rib 144. A width of the third rib 146 is less than a width of the first rib 142. The first rib 142, the second rib 144, and the third rib 146 advantageously provide structural rigidity to the column 140 such that the column 140 is substantially prevented from deflecting relative to the bottom surface 139.

Now referring to FIG. 4D a cross-sectional perspective view of an example sealing member 150 usable in the filter assembly 100 is shown. The sealing member 150 includes a sealing surface 152. As briefly described above, the sealing member 150 may be positioned within the valve port 120 such that the sealing surface 152 contacts the bottom surface 139 of the valve 130 when the valve 130 is in the closed position. The sealing surface 152 forms a radial seal with the bottom surface 139 of the valve 130. The sealing member 150 may be made of a plastic material, a metal material, and/or other suitable material.

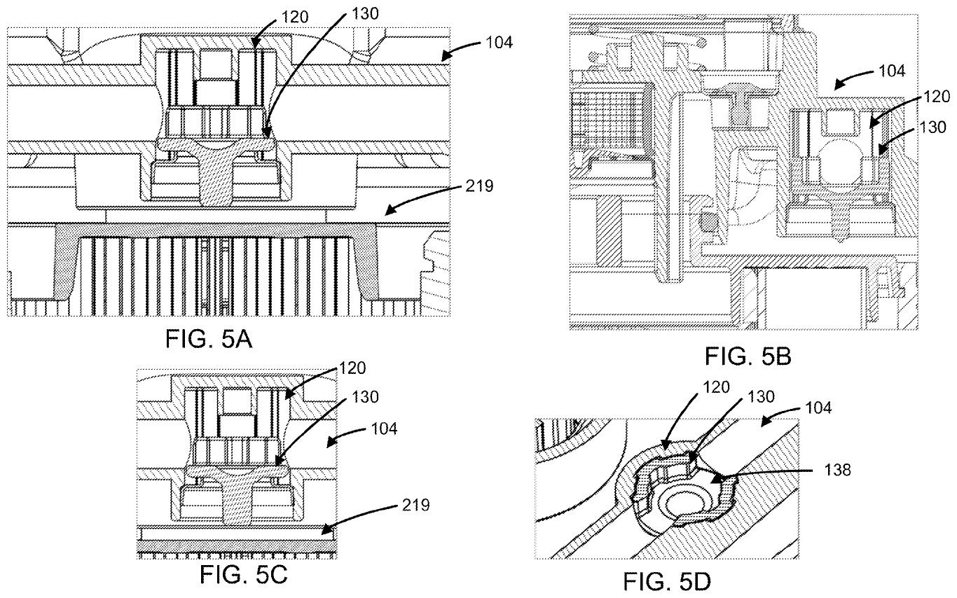

Now referring to FIGS. 5A-5D, various views of the filter assembly 100 are shown without a genuine filter element (e.g., the filter element 218). When the filter element 218 is not installed in the filter assembly 100, or when a non-genuine filter element 219 is installed in the filter assembly 100, the valve 130 is biased away from the valve port wall 121 (e.g., downwards) by the pressure of the fluid flowing through the port 104. More specifically, fluid flowing through the port 104 may enter the valve port 120, and flow into the channel 138. The pressure of the fluid may bias the valve 130 to the closed position. In the closed position, the valve 130 forms a radial seal with the sealing member 150. The valve 130 advantageously prevents a fluid (e.g., fuel) from flowing from the port 104 into the filter cartridge 200 when a non-genuine filter element 219 is installed in the filter assembly 100. As shown in FIG. 5D, when the valve 130 is in the closed position, the channel 138 may align with the port 104, such that a fluid may flow from the port 104 and through the channel 138.

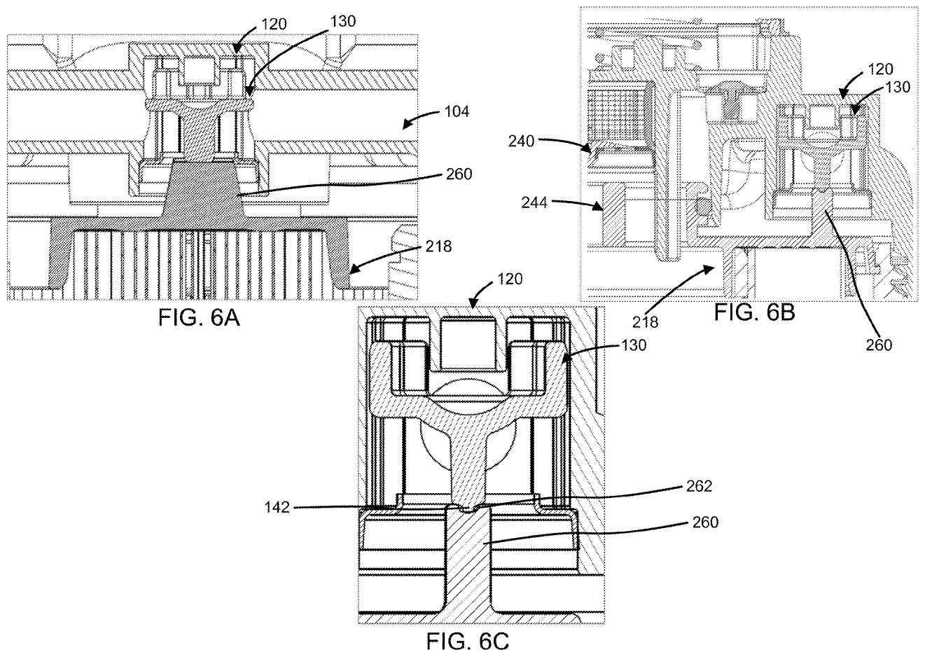

Now referring to FIGS. 6A-6C, various views of the filter assembly 100 are shown with the filter element 218. When the filter element 218 is installed in the filter assembly 100, the valve 130 is biased away from the valve port wall 121 (e.g., upwards) by the first arm 260. More specifically, the arm 260 contacts the column 140 and biases the valve 130 to the open position. In the open position, the valve 130 does not form a radial seal with the sealing member 150, and fluid is allowed to flow from the port 104, into the valve port 120, and into the filter element 218. The valve 130 advantageously allows the fluid (e.g., fuel) to flow from the port 104 into the filter cartridge 200 when the genuine filter element 218 is installed in the filter assembly 100.

As shown in FIG. 6C, the arm 260 includes an arm channel 262 that receives the distal end of the first rib 142 such that the distal end of the first rib 142 contacts a bottom surface of the channel 262 and a distal end of the second rib 144 contacts a top surface of the channel 262. The arm channel 262 substantially prevents the valve 130 from deflecting relative to the arm 260.

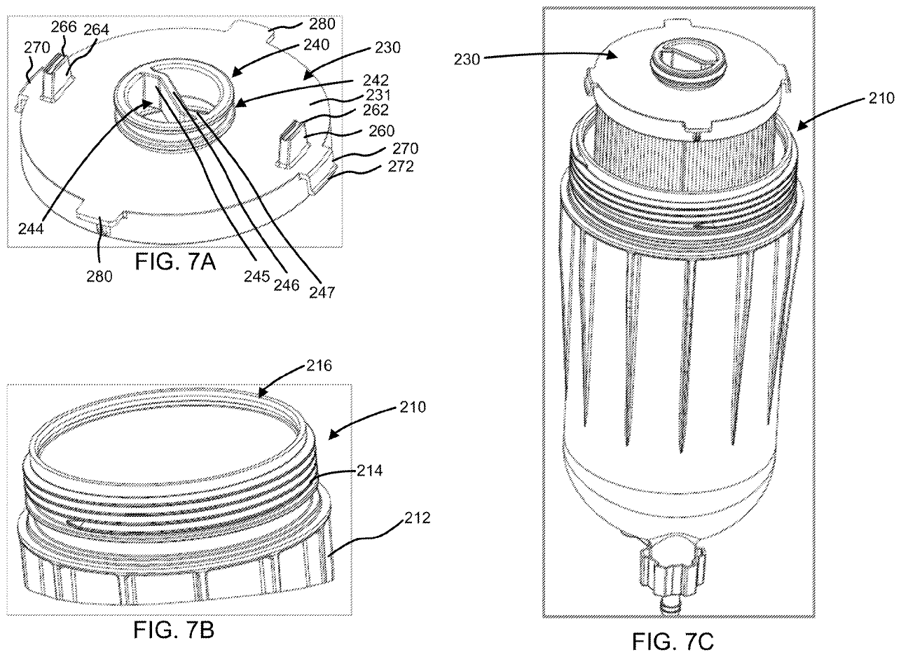

Now referring to FIG. 7A, a perspective view of the endplate 230 is shown, according to an example embodiment. As briefly described above, the endplate 230 includes the endplate end wall 231, the endplate port 240, the first arm 260, and the second arm 264. The first arm 260 includes the first arm channel 262. The second arm 264 includes a second arm channel 266. The endplate 230 also includes the first coupling members 270 and second coupling members 280. A radial flange 272 extends radially away from each of the first coupling members 270. The radial flanges 272 may enable coupling the endplate 230 to the shell 210. The second coupling members 280 may include one or more projections extending radially away from the endplate end wall 231. The second coupling members 280 contact a top surface of the shell 210 when the endplate 230 is coupled to the shell 210, such that the coupling members 280 substantially prevent the endplate 230 from translating towards the shell 210 (e.g., downwards).

As briefly described above, the endplate 230 also includes the endplate port 240. The endplate port 240 enables fluid communication between an inner volume of the filter element 218 and the pump port 112. The endplate port 240 includes the sealing channel 242 and the rib 244. The rib 244 includes one or more traverse portions shown as first traverse portion 245, a second traverse portion 246, and a third traverse portion 247. As shown, the first traverse portion 245 is substantially parallel to the third traverse portion 247, and the second traverse portion 246 is oblique relative to the first traverse portion 245 and the third traverse portion 247.

Now referring to FIG. 7B a perspective view of a portion of a shell 210 is shown, according to an example embodiment. The shell 210 includes a shell channel 216 defined on an inner surface of the shell wall 212. The shell channel 216 is structured to receive the radial flange 272 of the endplate 230 when the endplate 230 is coupled to the shell 210.

FIG. 7C is a perspective view of the filter element 218 including the endplate 230 being installed in the shell 210.

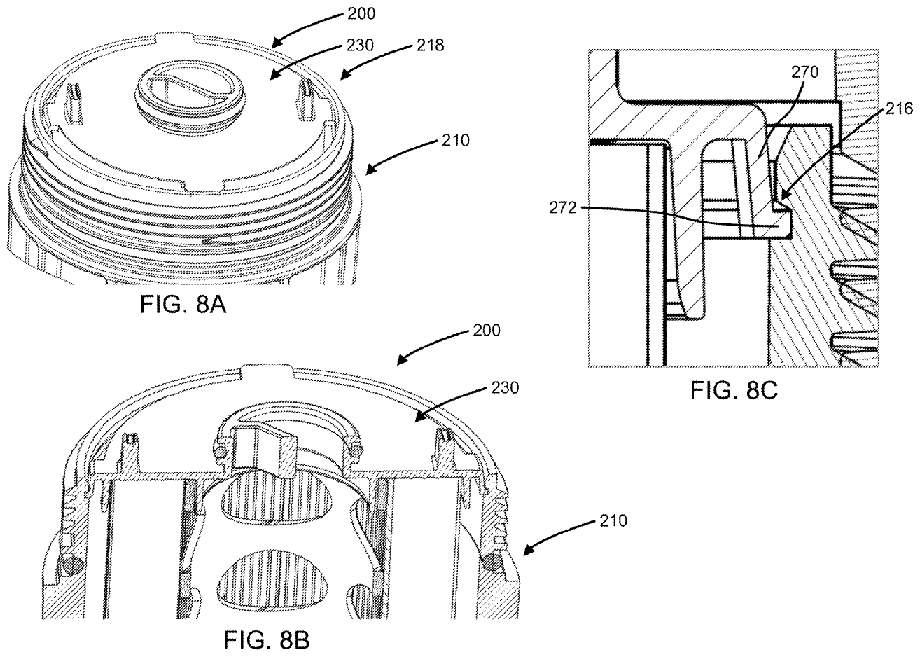

Now referring to FIGS. 8A-8C various views of the filter cartridge 200 are shown, according to an example embodiment. In particular, FIGS. 8A-8C show the filter element 218 coupled to the shell 210. As shown in FIG. 8C the radial flange 272 of the first coupling members 270 is received by the shell channel 216 such that the filter element 218 is coupled to the shell 210. As briefly described above, the shell channel 216 may receive the radial flange 272 in a snap fit arrangement. When the shell channel 216 receives the radial flange 272, the shell channel 216 substantially prevents the radial flange 272 from moving in the axial and radial directions, and enables the radial flange 272 to translate circumferentially within the shell channel 216 such that the filter element 218 may rotate relative to the shell 210.

Now referring to FIGS. 9A and 9B, cross-sectional views showing the filter cartridge 200 being installed in the filter head 102 are shown. As shown in FIGS. 9A and 9B, the filter head threads 114 engage the shell threads 214 such that the filter cartridge 200 is threadably coupled to the filter head 102. As the filter head threads 114 engage the shell threads 214 the prong 118 is received by the endplate port 240 such that the prong 118 contacts the rib 244. The prong 118 substantially prevents the endplate 230 from rotating as the shell 210 is rotated to engage the shell threads 214 to the filter head threads 114. It should be understood that the filter head 102 may be rotated relative to the shell 210 such that the prong 118 causes the endplate 230 to rotate relative to the shell 210 as the shell threads 214 engage the filter head threads 114.

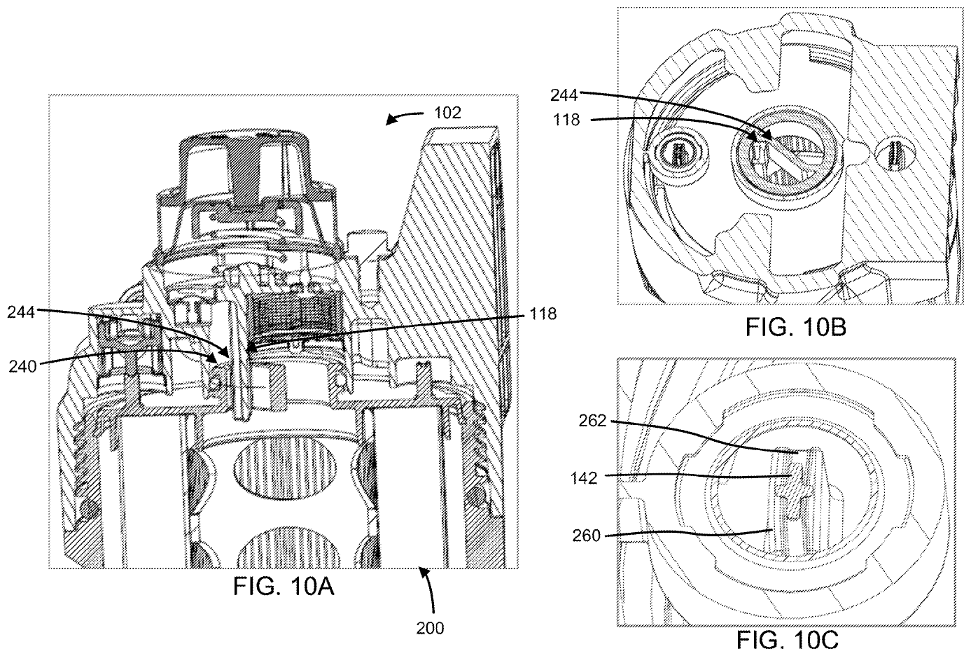

Now referring go FIGS. 10A-10C, cross-sectional views including portions of the filter assembly 100 in an assembled state are shown. As shown, the prong 118 is received by the endplate port 240 such that the prong 118 contacts the rib 244. The first rib 142 is received by the arm channel 262 such that the column 140 is substantially prevented from moving relative to the arm 260.

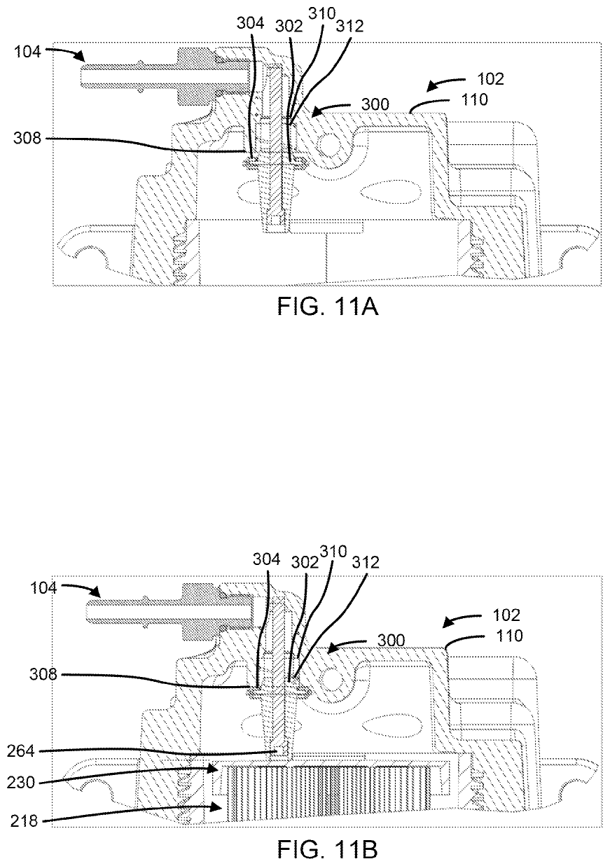

FIGS. 11A-11B are cross-sectional views showing a portion of the filter assembly 100 are shown, according to an example embodiment. The filter head 102 may include a valve port 310 that is structured to receive a valve assembly 300. The valve port 310 is in fluid communication with the internal volume of the shell 210 and at least one of the ports 104. In an example embodiment, the valve port 310 is in fluid communication with the port 104, and the port 104 is in fluid providing communication with a fluid source (e.g., a fuel tank). The valve port 310 defines a valve port sealing surface 308.

The valve assembly 300 includes a valve body 302 and a valve sealing member 304. The valve assembly 300 is operable between an open position and a closed position. In the open position, the valve assembly 300 allows a fluid (e.g., fuel, unfiltered fuel) to flow from the internal volume of the shell 210 to the port 104. The fluid then flows from the port 104 to a downstream component (e.g., a fluid source, a fuel tank). In the closed position, the valve sealing member 304 contacts the valve port sealing surface 308 and forms an axial seal therebetween, such that the fluid is substantially prevented from flowing from the internal volume of the shell 210 to the port 104. The valve assembly 300 may be biased to the open position by a biasing member shown as spring 312.

As shown in FIG. 11A, when a genuine filter element 218 is not installed in the filter assembly 100, the valve assembly 300 is biased to the open position by the spring 312. The valve assembly 300 advantageously allows a fluid (e.g., fuel) to flow back to the fluid source when a non-genuine filter element is installed in the filter assembly 100.

As shown in FIG. 11B, when a genuine filter element 218 is installed in the filter assembly 100, the arm 264 contacts the valve body 302 and biases the valve assembly 300 to the closed position (e.g., by compressing the spring 312). The valve assembly 300 advantageously allows a fluid (e.g., fuel) to be filtered by the filter element 218 when the genuine filter element 218 is installed in the filter assembly 100.

In some embodiments, when the genuine filter element 218 is installed in the filter assembly 100, an opening is defined between the endplate 230 and the valve body 302 such that at least a portion of the fluid (e.g., fuel and/or air) flows through the valve port 310. In these embodiments, only a portion of the fuel provided to the filter element 218 flows through the opening defined between the endplate 230 and the valve body 302.

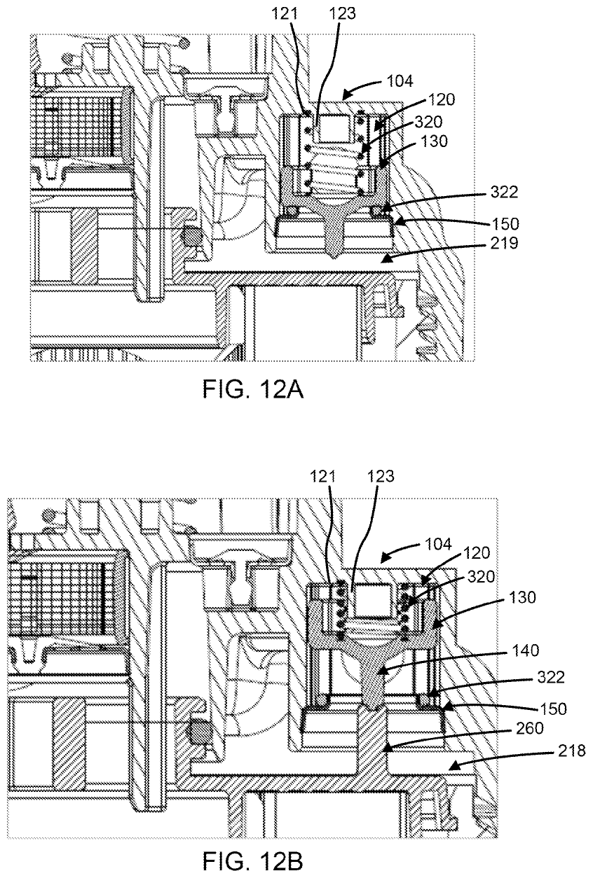

Now referring to FIGS. 12A and 12B, cross-sectional views showing a portion of the filter assembly 100 are shown, according to another embodiment. In some embodiments and as shown in FIGS. 12A and 12B, a biasing member shown as a spring 320 may be positioned within the valve port 120. As shown in FIG. 12A, the spring 320 biases the valve 130 to the closed position when the genuine filter element 218 is not installed and/or when a non-genuine filter element 219 is installed in the filter assembly 100. As shown in FIG. 12B, when the genuine filter element 218 is installed, the arm 260 contacts the column 140 of the valve 130 and biases the valve 130 to the open position (e.g., by compressing the spring 320).

In some embodiments, the sealing member 150 includes a second sealing member shown as an o-ring 322 (e.g., a gasket, etc.). The o-ring 322 contacts the valve 130 and the sealing member 150 and forms a radial seal therebetween when the valve 130 is in the closed position. The radial seal formed by the o-ring 322 substantially prevents a fluid from flowing from the port 104 into the filter cartridge 200. When the valve 130 is in the open position, the o-ring 322 does not contact the valve 130, and a fluid my flow between the valve 130 and the o-ring 322.

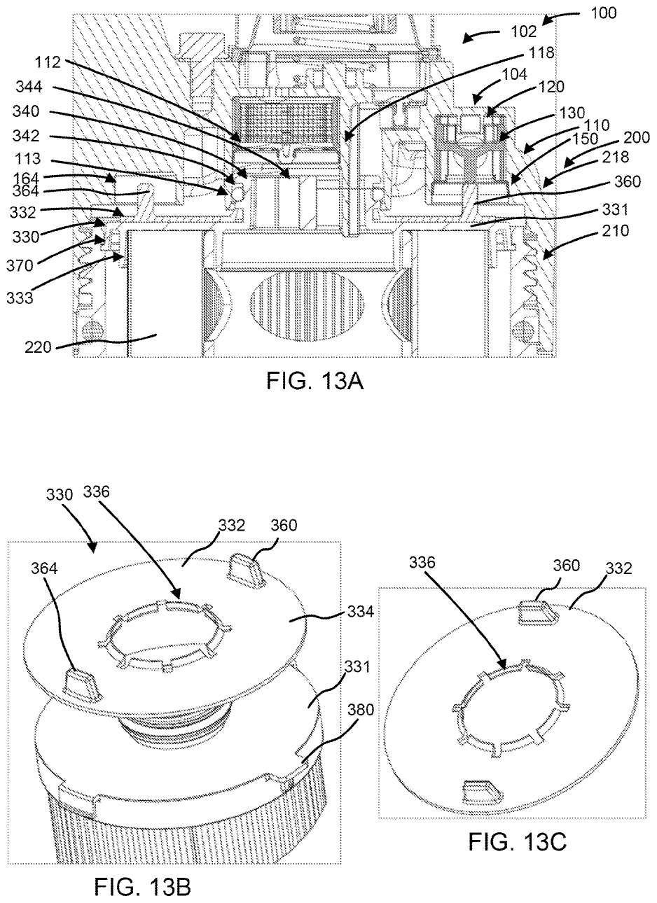

Referring generally to FIGS. 13A-15C, various embodiments of an endplate for use in the filter element 218 are shown. In contrast with the endplate 230 described herein with respect to FIGS. 1A-12B, the endplates 330, 430, 530 include two separate endplate portions.

As shown in FIGS. 13A-13C, the filter assembly 100 includes a filter head 102, and a filter cartridge 200. The filter head 102 may be substantially similar to or the same as the filter head 102 described herein with respect to FIG. 2A. For example, the filter head 102 includes one or more ports 104, a filter head wall 110, a pump port 112, a valve port 120, a valve 130, and a sealing member 150. The filter cartridge 200 includes a shell 210 and a filter element 218. The filter element 218 includes a filter media 220 and an endplate 330.

The endplate 330 includes an endplate first portion 331 and an endplate second portion 332. The endplate first portion 331 includes a filter media channel 333 that is substantially similar to or the same as filter media channel 232, an endplate port 340 that is substantially similar to or the same as the endplate port 240, one or more coupling member 370 that are substantially similar to or the same as the coupling members 270, and one or more coupling member 380 that are substantially similar to or the same as the coupling members 280.

The endplate second portion 332 includes a second portion end wall 334. The endplate second portion 332 also includes a first arm 360 and a second arm 364 that extend axially away from the second portion end wall 334. The first arm 360 and the second arm 364 are substantially similar to or the same as the first arm 260 and the second arm 264, respectively. The second portion end wall 334 also defines an endplate opening 336. The endplate opening 336 receives the endplate port 340 when the endplate second portion 332 is coupled to the endplate first portion 331.

In some embodiments, the endplate port 340 also includes a rib 344 that is substantially similar to or the same as rib 244. For example, the rib 344 may be structured to contact the prong 118 when the filter cartridge 220 is coupled to the filter head 102 such that the endplate 330 rotates relative to the shell 210.

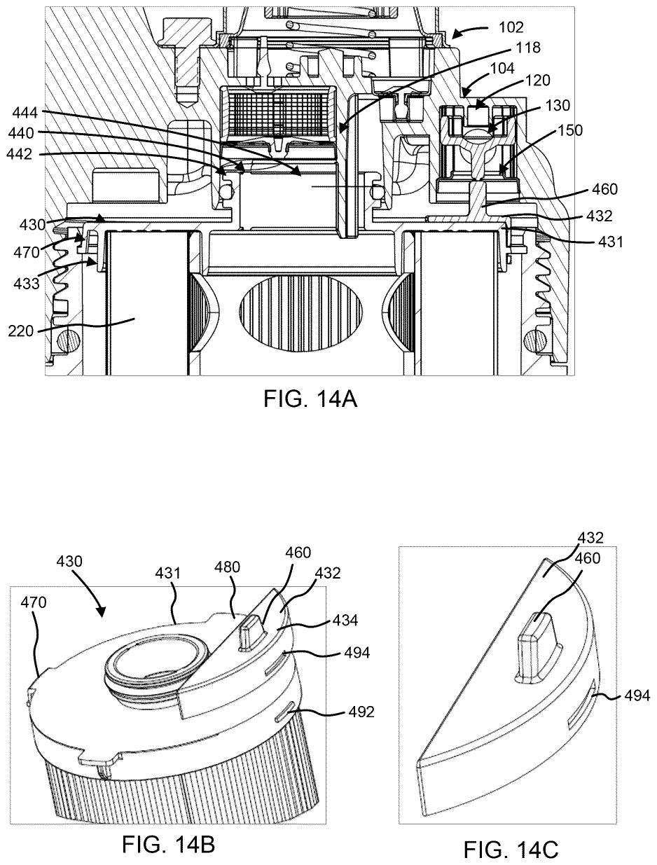

Now referring to FIGS. 14A-14C, the filter assembly 100 includes a filter head 102, and a filter cartridge 200. The filter head 102 may be substantially similar to or the same as the filter head 102 described herein with respect to FIG. 2A. For example, the filter head 102 includes one or more ports 104, a filter head wall 110, a pump port 112, a valve port 120, a valve 130, and a sealing member 150. The filter cartridge 200 includes a shell 210 and a filter element 218. The filter element 218 includes a filter media 220 and an endplate 430.

The endplate 430 includes an endplate first portion 431 and an endplate second portion 432. The endplate first portion 431 includes a filter media channel 433 that is substantially similar to or the same as filter media channel 232, an endplate port 440 that is substantially similar to or the same as the endplate port 240, one or more coupling member 470 that are substantially similar to or the same as the coupling members 270, and one or more coupling member 480 that are substantially similar to or the same as the coupling members 280. The endplate first portion 431 also includes a flange 492 extending radially away from the filter media channel 433.

The endplate second portion 432 includes an endplate surface 434. The endplate second portion 432 also includes a first arm 460 that extends axially away from the endplate surface 434. The first arm 360 is substantially similar to or the same as the first arm 260. The endplate second portion 432 includes a slot 494 that is configured to receive the flange 492 such that the endplate second portion 432 is coupled to the endplate first portion 431 when the flange 492 is received by the slot 494.

In some embodiments, the endplate port 440 also includes a rib 444 that is substantially similar to or the same as rib 244. For example, the rib 444 may be structured to contact the prong 118 when the filter cartridge 220 is coupled to the filter head 102 such that the endplate 430 rotates relative to the shell 210.

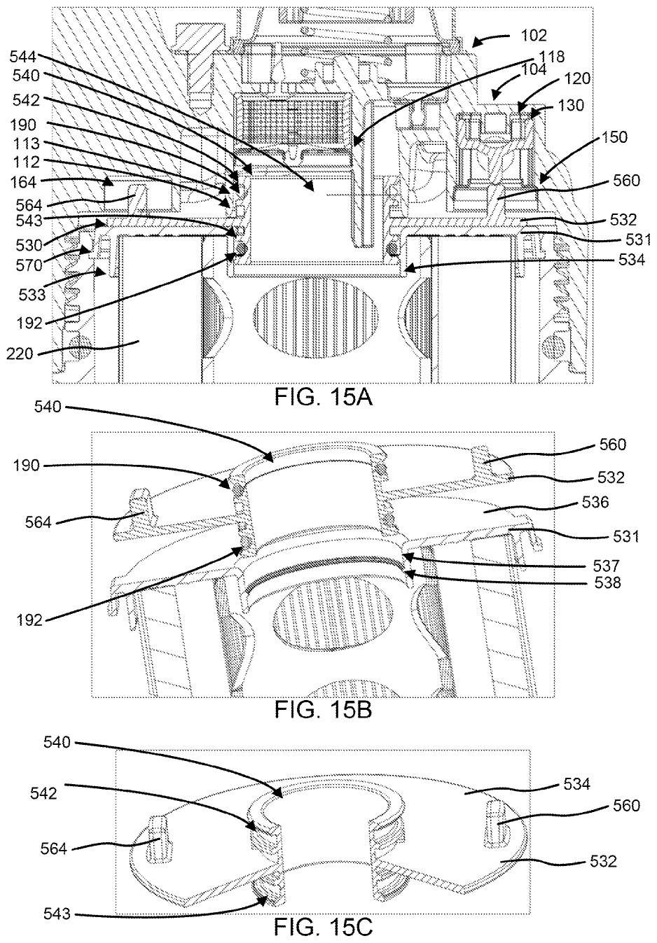

Now referring to FIGS. 15A-15C, the filter assembly 100 includes a filter head 102 and a filter cartridge 200. The filter head 102 may be substantially similar to or the same as the filter head 102 described herein with respect to FIG. 2A. For example, the filter head 102 includes one or more ports 104, a filter head wall 110, a pump port 112, a valve port 120, a valve 130, and a sealing member 150. The filter cartridge 200 includes a shell 210 and a filter element 218. The filter element 218 includes a filter media 220 and an endplate 530.

The endplate 530 includes an endplate first portion 531 and an endplate second portion 532. The endplate first portion 531 includes a filter media channel 533 that is substantially similar to or the same as filter media channel 232, and one or more coupling member 470 that are substantially similar to or the same as the coupling members 270. The endplate first portion also includes a first portion end wall 536 and a first portion port 537 that extends axially away from the first portion end wall 536 in a first direction (e.g., downwards). The first portion port 537 defines a sealing surface 538.

The endplate second portion 532 includes a second portion end wall 534. The endplate second portion 532 also includes a first arm 560 and a second arm 564 that extend axially away from the second portion end wall 534. The first arm 560 and the second arm 564 are substantially similar to or the same as the first arm 260 and the second arm 264, respectively.

The endplate second portion 532 includes a second portion port 540 that extends axially away from the second portion end wall 534 in a first direction and a second direction (e.g. upwards and downwards). The second portion port 540 includes a first sealing member channel 542 and a second sealing member channel 543. The first sealing member channel 542 is configured to receive a first sealing member 190. The first sealing member 190 contacts the filter head sealing surface 113 of the pump port 112 and the first sealing member channel 542 and forms a radial seal therebetween. The second sealing member channel 543 is configured to receive a second sealing member 192. The second sealing member 192 contacts the sealing surface 538 of the first portion port 537 and the second sealing member channel 543 and forms a radial seal therebetween.

In some embodiments, the second portion port 540 also includes a rib 544 that is substantially similar to or the same as rib 244. For example, the rib 544 may be structured to contact the prong 118 when the filter cartridge 220 is coupled to the filter head 102 such that the endplate 530 rotates relative to the shell 210.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various example embodiments without departing from the scope of the concepts presented herein

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

1. A filter assembly comprising:
a filter head comprising:
a first port;
a second port;
a valve positioned within the first port; and
a prong extending through the second port; and
a filter cartridge removably coupled to the filter head, the filter cartridge comprising:
a shell having a shell wall defining an internal volume; and
a filter element disposed within the internal volume such that the prong extends axially towards the filter element, the filter element comprising:
filter media; and
a first endplate coupled to the filter media at a filter media first end, the first endplate comprising:
an endplate end wall; and
an arm extending axially away from the endplate end wall in a first direction, away from the filter media, such that the arm contacts the valve.

2. (canceled)

3. The filter assembly of claim 1, wherein the first endplate further comprises:
an endplate port extending axially away from the endplate end wall; and
a rib extending across the endplate port, such that the rib contacts the prong when the filter cartridge is coupled to the filter head.

4. The filter assembly of claim 1, wherein:
the shell comprises a shell channel defined on an inner surface of the shell wall; and
the first endplate further comprises:
one or more first coupling members extending radially away from the endplate end wall; and
a radial flange extending radially away from each of the one or more first coupling members, wherein the radial flange is received by the shell channel such that the filter element is coupled to the shell.

5. The filter assembly of claim 4, further comprising one or more second coupling members, the one or more second coupling members including one or more projections extending radially away from the endplate end wall, the one or more second coupling members contacting a top surface of the shell.

6. The filter assembly of claim 1, wherein the first port defines a first port sealing surface.

7. The filter assembly of claim 6, wherein the valve comprises a valve sealing member;
wherein the valve is operable between an open position and a closed position; and
wherein the valve sealing member engages the first port sealing surface when the valve is in the closed position.

8. The filter assembly of claim 1, wherein the first endplate further comprises an endplate first portion comprising:
the endplate end wall;
a filter media channel extending axially away from the endplate end wall and sized to receive the filter media; and
an endplate port extending axially away from the endplate end wall.

9. The filter assembly of claim 8, wherein the first endplate further comprises an endplate second portion comprising:
a second portion end wall defining an endplate opening sized to receive the endplate port; and
the arm.

10. The filter assembly of claim 9, wherein:
the endplate first portion further comprises a flange extending radially away from the filter media channel; and
the endplate second portion further comprises a slot configured to receive the flange.

11. The filter assembly of claim 9, wherein the endplate second portion further comprises a second portion port extending axially away from the second portion end wall in the first direction and in a second direction, opposite the first direction.

12. The filter assembly of claim 1, wherein the valve comprises:
a valve wall;
a first sidewall extending away from the valve wall in a second direction;
a second sidewall extending away from the valve wall in the second direction; and
a column extending away from the valve wall in a third direction, opposite the second direction.

13. The filter assembly of claim 12, wherein the column comprises:
a first rib extending axially away from a bottom surface of the valve wall;
a second rib extending axially away from the bottom surface of the valve wall and substantially perpendicular to the first rib; and
a third rib spaced away from the bottom surface of the valve wall and substantially parallel to the bottom surface and perpendicular to the first rib.

14. A filter head assembly comprising:
a filter head comprising a port; and
a valve disposed within the port, the valve comprising:
a valve wall;
a first sidewall extending away from the valve wall in a first direction;
a second sidewall extending away from the valve wall in the first direction; and
a column extending away from the valve wall in a second direction, opposite the first direction.

15. The filter head assembly of claim 14, wherein the first sidewall and the second sidewall are spaced away from each other, such that the first sidewall and the second sidewall cooperate to define a channel.

16. The filter head assembly of claim 14, wherein the first sidewall defines one or more recesses sized to receive a projection of a valve port.

17. The filter head assembly of claim 14, wherein the column comprises:
a first rib extending axially away from a bottom surface of the valve wall;
a second rib extending axially away from the bottom surface of the valve wall and substantially perpendicular to the first rib; and
a third rib spaced away from the bottom surface of the valve wall and substantially parallel to the bottom surface and perpendicular to the first rib.

18. The filter head assembly of claim 17, wherein:
a distal end of the first rib extends past a distal end of the second rib; and
a width of the third rib is less than a width of the first rib.

19. A method of installing a filter cartridge with a filter head comprising:
rotating the filter cartridge relative to the filter head such that a shell thread of a shell of the filter cartridge engages a filter head thread of the filter head,
contacting a prong of the filter head with a rib of an endplate of the filter cartridge, thereby preventing further rotation of the endplate of the filter cartridge relative to the filter head.

20. The method of claim 19, further comprising translating the filter cartridge relative to the filter head as the filter cartridge is rotated relative to the filter head such that a first arm of the filter cartridge is at least partially received by a valve port of the filter head, wherein the first arm contacts a portion of a valve disposed within the valve port such that the first arm biases the valve to an open position.

21. A filter assembly comprising:
a filter head comprising:
a first port; and
a valve positioned within the first port, the valve comprising:
a valve wall;
a first sidewall extending away from the valve wall in a second direction;
a second sidewall extending away from the valve wall in the second direction; and
a column extending away from the valve wall in a third direction, opposite the second direction; and
a filter cartridge removably coupled to the filter head, the filter cartridge comprising:
a shell having a shell wall defining an internal volume; and
a filter element disposed within the internal volume and comprising:
filter media; and
a first endplate coupled to the filter media at a filter media first end, the first endplate comprising:
an endplate end wall; and
an arm extending axially away from the endplate end wall in a first direction, away from the filter media, such that the arm contacts the valve.

22. The filter assembly of claim 21, wherein the column comprises:
a first rib extending axially away from a bottom surface of the valve wall;
a second rib extending axially away from the bottom surface of the valve wall and substantially perpendicular to the first rib; and
a third rib spaced away from the bottom surface of the valve wall and substantially parallel to the bottom surface and perpendicular to the first rib.

23. A filter assembly comprising:
a filter head comprising:
a first port; and
a valve positioned within the first port; and
a filter cartridge removably coupled to the filter head, the filter cartridge comprising:
a shell having a shell wall defining an internal volume; and
a filter element disposed within the internal volume and comprising:
filter media; and
a first endplate coupled to the filter media at a filter media first end, the first endplate comprising:
an endplate first portion comprising:
an endplate end wall;
an endplate port extending axially away from the endplate end wall; and
an endplate second portion comprising:
a second portion end wall defining an endplate opening sized to receive the endplate port; and
an arm extending axially away from the endplate end wall in a first direction, away from the filter media, such that the arm contacts the valve.

24. The filter assembly of claim 23, wherein the endplate first portion further comprises a filter media channel extending axially away from the endplate end wall and sized to receive the filter media.

25. The filter assembly of claim 24, wherein:
the endplate first portion further comprises a flange extending radially away from the filter media channel; and
the endplate second portion further comprises a slot configured to receive the flange.

26. The filter assembly of claim 23, wherein the endplate second portion further comprises a second portion port extending axially away from the second portion end wall in the first direction and in a second direction, opposite the first direction.

27. A filter assembly comprising:
a filter head comprising:
a first port; and
a valve positioned within the first port; and
a filter cartridge removably coupled to the filter head, the filter cartridge comprising:
a shell having a shell wall defining an internal volume, the shell comprising a shell channel defined on an inner surface of the shell wall; and
a filter element disposed within the internal volume and comprising:
filter media; and
a first endplate coupled to the filter media at a filter media first end, the first endplate comprising:
an endplate end wall;
an arm extending axially away from the endplate end wall in a first direction, away from the filter media, such that the arm contacts the valve;
one or more first coupling members extending radially away from the endplate end wall; and
a radial flange extending radially away from each of the one or more first coupling members, wherein the radial flange is received by the shell channel such that the filter element is coupled to the shell.

28. The filter assembly of claim 27, further comprising one or more second coupling members, the one or more second coupling members including one or more projections extending radially away from the endplate end wall, the one or more second coupling members contacting a top surface of the shell.
